(19) United States
(12) Patent Application Publication
(10) Pub. No.: US 2026/0285288 A1
(43) Pub. Date: Sep. 24, 2026

(54) CONTROLLER FOR PLUG-IN HYBRID ELECTRIC VEHICLE

(71) Applicant: TOYOTA JIDOSHA KABUSHIKI KAISHA, Toyota-shi (JP)

(72) Inventor: Keisuke MORISAKI, Toyota-shi (JP)

(73) Assignee: TOYOTA JIDOSHA KABUSHIKI KAISHA, Toyota-shi (JP)

(21) Appl. No.: 19/425,333

(22) Filed: Dec. 18, 2025

(30) Foreign Application Priority Data
Mar. 19, 2025 (JP) 2025-044885

(51) Int. Cl. B60W 20/13; B60L 53/16; B60W 10/06; B60W 10/26; B60W 50/00; B60W 50/14; G06Q 50/06; B60K 6/40; B60L 55/00

(52) U.S. Cl. CPC B60W 20/13; B60L 53/16; B60W 10/06; B60W 10/26; B60W 50/0097; B60W 50/14; G06Q 50/06; B60K 6/40; B60L 55/00; B60W 2050/146; B60W 2510/06; B60W 2510/244; B60W 2710/06; B60W 2710/244; B60Y 2200/92; B60Y 2300/91

(57) ABSTRACT

Processing circuitry of a controller acquires a travel route to a destination. The processing circuitry acquires a predicted arrival time at the destination. The processing circuitry acquires a first amount of electrical energy that is an amount of electrical energy stored in a battery cell. The processing circuitry acquires a second amount of electrical energy that is an amount of electrical energy required to participate in a demand response. The processing circuitry predicts the first amount of electrical energy at the time of arrival at the destination. The processing circuitry executes a power reserve control when predicting that the first amount of electrical energy at the time of arrival at the destination will be less than the second amount of electrical energy.

### CROSS-REFERENCE TO RELATED APPLICATIONS

This application is based upon and claims the benefit of priority from Japanese Patent Application No. 2025-044885, filed on March 19, 2025, the entire contents of which are incorporated herein by reference.

### BACKGROUND

### 1. Field

The present disclosure relates to a controller for a plug-in hybrid electric vehicle.

### 2. Description of Related Art

In recent years, the concept of a virtual power plant (VPP), which provides functionality equivalent to that of a power plant by controlling consumer-side power resources, has become widespread.

JP2022-155265A discloses a power supply management system in which the output of a stationary fuel cell, serving as a power resource, is controlled in accordance with fluctuations in overall power demand of the power grid, thereby regulating the supply-demand balance of power within the grid.

In connection with VPPs, the concept of demand response (DR) has also become prevalent. In DR, the demand profile of electricity supplied from the power grid to consumers is modified by controlling consumer-side power resources. In certain instances, DR requires consumer-side power resources to supply power in order to reduce the electricity supplied from the power grid to consumers.

An electric vehicle can be employed as a consumer-side power resource. In such cases, by supplying to the consumer the electric power stored in the battery cells of the electric vehicle, a load reduction DR can be achieved, in which the electricity supplied from the power grid to the consumer is decreased. However, if the amount of electrical energy stored in the battery cells of the electric vehicle is less than the amount of electrical energy required to participate in the load reduction DR, participation of the electric vehicle in the load reduction DR may lead to depletion of the battery of the electric vehicle. Accordingly, when the amount of electrical energy stored in the battery cells of the electric vehicle is less than the amount required for participation in the load reduction DR, the electric vehicle cannot be permitted to participate in the load reduction DR.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a controller for a plug-in hybrid electric vehicle is provided. The plug-in hybrid electric vehicle includes an engine and a motor-generator that are power sources for driving drive wheels, a battery cell that supplies electric power to the motor-generator, and stores electric energy generated by the motor-generator using output of the engine, and a connection port configured to electrically connect an external charging and discharging device and the battery cell. The plug-in hybrid electric vehicle is configured to participate in a demand response by being electrically connected to the charging and discharging device. The controller includes processing circuitry. The processing circuitry is configured to acquire a travel route to a destination where the charging and discharging device is provided, acquire an expected time of arrival at the destination, acquire a first amount of electrical energy that is an amount of electrical energy stored in the battery cell, and acquire a second amount of electrical energy that is an amount of electrical energy required for the plug-in hybrid electric vehicle to participate in the demand response. The processing circuitry is also configured to predict whether the first amount of electrical energy at the time of arrival at the destination will be less than the second amount of electrical energy using the acquired travel route, the estimated arrival time, the first amount of electrical energy, and the second amount of electrical energy. The processing circuitry is further configured to, when predicting that the first amount of electrical energy at the time of arrival at the destination will be less than the second amount of electrical energy, execute a power reserve control to increase opportunities to operate the engine such that the first amount of electrical energy at the time of arrival at the destination will be greater than or equal to the second amount of electrical energy.

Other features and aspects will be apparent from the following detailed description, the drawings, and the claims.

### BRIEF DESCRIPTION OF THE DRAWINGS

FIG. 1 is a schematic diagram showing a charging and discharging system according to a first embodiment.

FIG. 2 is a flowchart showing a series of processes performed by the processing circuitry shown in FIG. 1.

FIG. 3 is a schematic diagram showing a plug-in hybrid electric vehicle according to a second embodiment.

FIG. 4 shows an example of an image displayed on the display shown in FIG. 3.

FIG. 5 is a flowchart illustrating a series of processes performed by processing circuitry according to a third embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

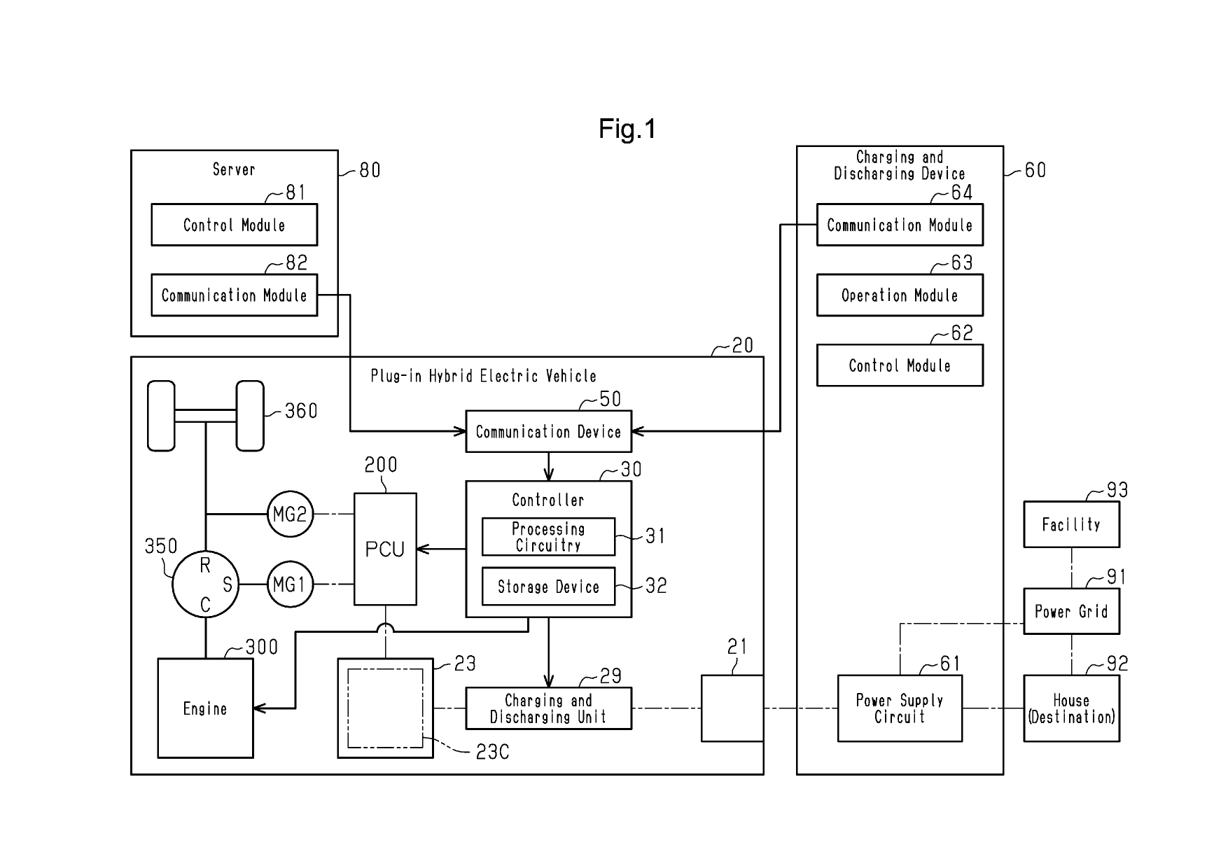

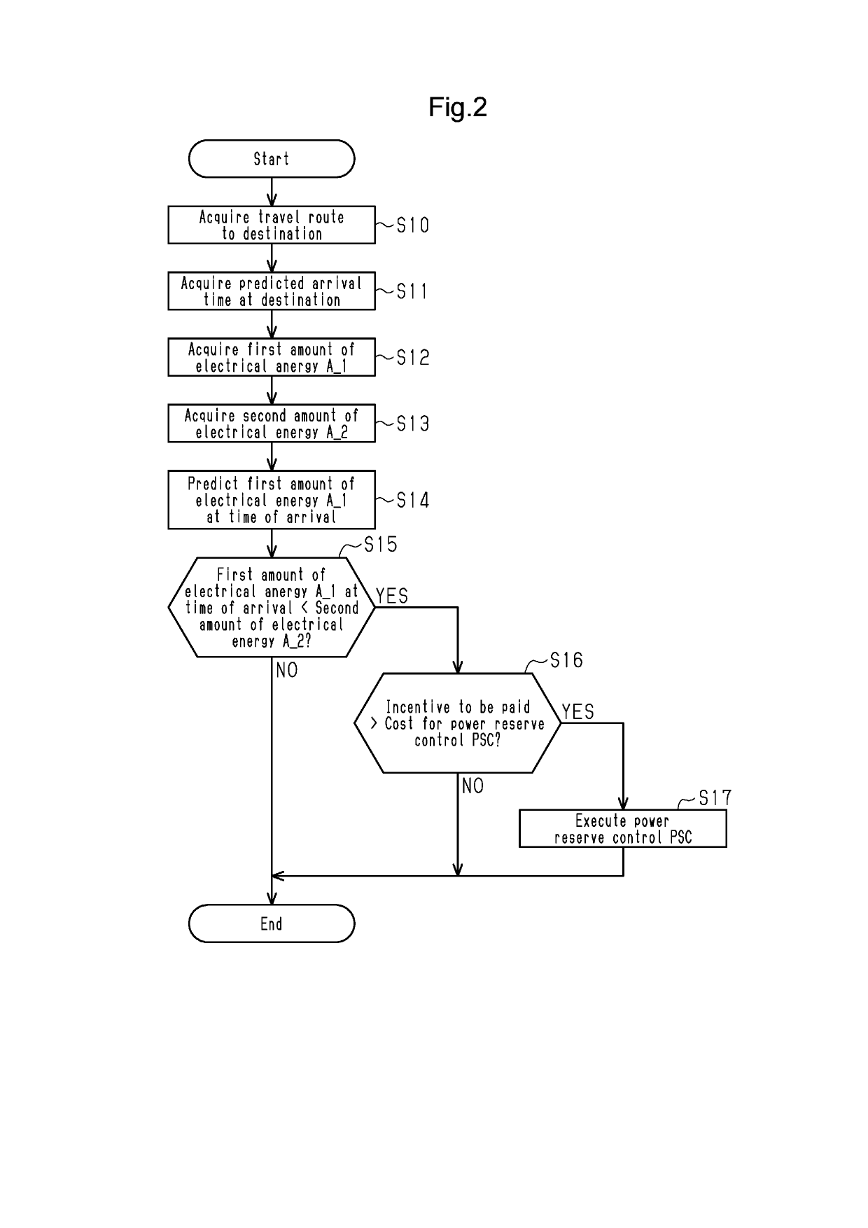

Hereinafter, a controller of a plug-in hybrid electric vehicle (PHEV) 20 according to a first embodiment will be described with reference to FIGS. 1 and 2.

FIG. 1 shows the PHEV 20, a charging and discharging device 60, and a server 80.

### PHEV 20

As shown in FIG. 1, the PHEV 20 includes an engine 300 as a power source, and two motor-generators. A crankshaft of the engine 300 is mechanically connected to a carrier C of a planetary gear mechanism 350 constituting a power split mechanism. The carrier C holds rotation shafts of multiple pinion gears included in the planetary gear mechanism 350.

A rotation shaft of the first motor-generator MG1 is mechanically connected to a sun gear S of the planetary gear mechanism 350. A rotary shaft of the second motor-generator MG2 and the drive wheels 360 are mechanically connected to a ring gear R of the planetary gear mechanism 350.

The first motor-generator MG1 functions as a power generator that generates electric power using the output of the engine 300, and also functions as a start-up cranking motor that cranks the crankshaft when the engine 300 is started.

The second motor-generator MG2 functions as a motor that generates a driving force for the drive wheels 360, and functions as a power generator that generates electric power by regeneration during deceleration of the PHEV 20.

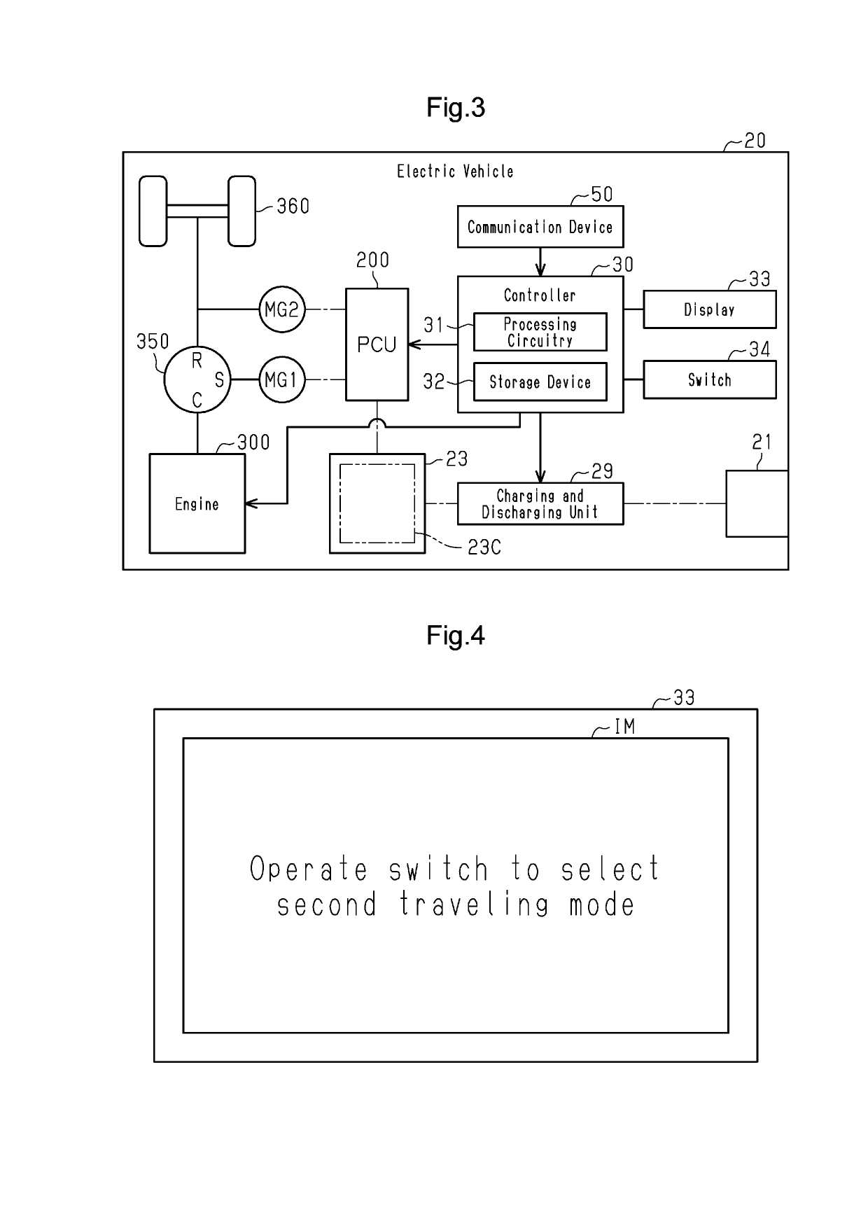

The PHEV 20 includes a battery pack 23 accommodating multiple battery cells 23C therein. In FIGS. 1 and 3, multiple battery cells 23C laid in the battery pack 23 are collectively surrounded by a chain line. Processing circuitry 31 can acquire the first amount of electrical energy A_1 which is the total amount of electrical energy stored in the multiple battery cells 23C.

Both of the first motor-generator MG1 and the second motor-generator MG2 exchange electric power with the battery cells 23C via a power control unit (PCU) 200. The battery cells 23C store electric power generated by the first motor-generator MG1 using the output of the engine 300. The battery cells 23C supply electric power to the first motor-generator MG1 and the second motor-generator MG2. The PCU 200 includes converters and inverters. The converter boosts DC power input from the battery cells 23C and outputs the boosted power. The inverters convert the DC power boosted by the converter into AC power and output the AC power to the first motor-generator MG1 and the second motor-generator MG2.

The PHEV 20 includes a controller 30. The controller 30 includes the processing circuitry 31 that executes a program to perform various processes and a storage device 32 in which the program is stored. The processing circuitry 31 includes a processor. The storage device 32 can store various types of data.

The processing circuitry 31 can acquire the first amount of electrical energy A_1 which is the amount of electrical energy stored in the battery cells 23C. The processing circuitry 31 can select a traveling mode of PHEV 20. The traveling mode of the PHEV 20 includes a first traveling mode and a second traveling mode. In the first traveling mode, the PHEV 20 is caused to travel by using the output of the motor-generator in a state in which the engine 300 is stopped. In the second traveling mode, the engine 300 is operated to cause the PHEV 20 to travel.

The PHEV 20 includes a connection port 21 and a charging and discharging unit 29. A connector connected to a charging and discharging cable of the charging and discharging device 60 can be connected to the connection port 21. In a state in which the connector is connected to the connection port 21, the battery cells 23C are in a chargeable and dischargeable state. That is, the connection port 21 is configured to electrically connect the external charging and discharging device 60 and the battery cells 23C.

### Charging and Discharging Device 60 and Server 80

The charging and discharging device 60 is provided in a house 92 of a user of the PHEV 20. The charging and discharging device 60 includes a power supply circuit 61, a control module 62, an operation module 63, and a communication module 64. The charging and discharging device 60 is so-called electric vehicle supply equipment (EVSE). The power supply circuit 61 is connected to an end of the power supply cable opposite to the connector. The power supply circuit 61 is connected to an external power grid 91. The power supply circuit 61 can input electricity from the power grid 91 to the PHEV 20 via a power supply cable. The power supply circuit 61 is connected to an external house 92. The power supply circuit 61 can input electricity from the PHEV 20 to the house 92. The power supply circuit 61 can input electricity from the PHEV 20 to the power grid 91. The electricity input to the power grid 91 can be supplied to a facility 93 other than the house 92 via the power grid 91.

The operation module 63 receives an operation from a user of the charging and discharging device 60. The operation module 63 is, for example, a touch display. The communication module 64 communicates with the communication device 50 in the PHEV 20 via a wireless communication network. The control module 62 transmits a request related to charging and discharging of the PHEV 20 from the communication module 64 to the PHEV 20 based on the operation signal received by the operation module 63.

The server 80 includes a control module 81 and a communication module 82. The communication module 82 communicates with the communication device 50 in the PHEV 20 via a wireless communication network. The control module 81 performs charge and discharge control using the PHEV 20 as a demand response (hereinafter referred to as DR) resource. When the control module 81 performs the charge/discharge control, the control module 81 transmits a request related to the charge/discharge of the PHEV 20 from the communication module 82 to the PHEV 20. To be specific, the control module 81 transmits a demand response request (hereinafter, referred to as a DR request) for requesting participation in the DR to the PHEV 20.

The DR request includes the second amount of electrical energy A_2, which is the amount of electrical energy required for the PHEV 20 to participate in the DR. The DR request includes an incentive INC to be paid to the user of PHEV 20 when the PHEV 20 participates in the DR. The DR request includes a participation time at which the PHEV 20 participates in the DR.

The server 80 determines that the PHEV 20 has participated in the DR when the PHEV 20 and the charging and discharging device 60 are electrically connected to each other and the first amount of electrical energy A_1 of the PHEV 20 is greater than or equal to the second amount of electrical energy A_2 at the participation time. Whether the PHEV 20 has supplied the electric power stored in the battery cells 23C to the charging and discharging device 60 may be included in the condition for determining whether the PHEV 20 has participated in the DR. For example, when the PHEV 20 supplies the electric power stored in the battery cells 23C to the charging and discharging device 60, the server 80 may determine that the PHEV 20 has participated in the DR.

### Processing by the Processing Circuitry 31

The processing circuitry 31 of the controller 30 performs a series of processes for determining whether to execute the power reserve control PSC. The power reserve control PSC is control for increasing the opportunities to operate the engine 300 such that the first amount of electrical energy A_1 at the time of arrival at a destination, where the charging and discharging device 60 is provided, will be greater than or equal to the second amount of electrical energy A_2. The processing circuitry 31 executes the series of processes at each prescribed execution cycle during traveling on the PHEV 20. In the following description, the number of each step is represented by the letter S followed by a numeral.

As shown in FIG. 2, when the series of processes is started, in the S10 process, the processing circuitry 31 acquires a travel route to a destination where the charging and discharging device 60 is provided. The destination is, for example, a house 92. Thereafter, the processing circuitry 31 advances the process to S11.

In the S11 process, the processing circuitry 31 acquires the predicted arrival time at the destination. Thereafter, the processing circuitry 31 advances the process to S12.

The travel route to the destination and the expected arrival time may be acquired from a server that provides a navigation service through the communication device 50. The travel route to the destination and the estimated time of arrival may be acquired from navigation systems mounted on the PHEV 20.

In the process of S12, the processing circuitry 31 acquires a first amount of electrical energy A_1, which is the amount of electrical energy stored in the battery cells 23C. Thereafter, the processing circuitry 31 advances the process to S13.

In the process of the S13, the processing circuitry 31 acquires the second amount of electrical energy A_2 which is an amount of electrical energy required for causing the PHEV 20 to participate in the DR. Thereafter, the processing circuitry 31 advances the process to S14.

In the S14 process, the processing circuitry 31 predicts the first amount of electrical energy A_1 at the time of arrival at the destination using the acquired travel route, the estimated time of arrival, and the first amount of electrical energy A_1. Thereafter, the processing circuitry 31 advances the process to S15.

In the S15 process, the processing circuitry 31 uses the first amount of electrical energy A_1 at the time of arrival at the destination and the acquired second amount of electrical energy A_2 to predict whether the first amount of electrical energy A_1 at the time of arrival at the destination will be less than the second amount of electrical energy A_2. In a case in which predicting that the first amount of electrical energy A_1 at the time of arrival at the destination will be greater than or equal to the second amount of electrical energy A_2 (S15: NO), the processing circuitry 31 temporarily ends the series of processes. When predicting that the first amount of electrical energy A_1 at the time of arrival at the destination will be less than the second amount of electrical energy A_2 (S15: YES), the processing circuitry 31 advances the process to S16.

In the S16 process, the processing circuitry 31 acquires an incentive INC to be paid to the user of the PHEV 20 when the PHEV 20 participates in the DR. The processing circuitry 31 acquires data related to the incentive INC from the server 80, for example. The processing circuitry 31 acquires the cost for the power reserve control PSC. The processing circuitry 31 determines whether the incentive INC paid to the user of the PHEV 20 exceeds the cost required for the power reserve control PSC.

The cost required for the power reserve control PSC is, for example, the product of the difference obtained by subtracting the amount of fuel predicted to be consumed when the power reserve control PSC is not executed from the amount of fuel predicted to be consumed when the power reserve control PSC is executed, and the fuel cost. For example, the processing circuitry 31 acquires the fuel cost from the server 80.

When the incentive INC is less than or equal to the cost required for the power reserve control PSC (S16: NO), the processing circuitry 31 temporarily ends this series of processes. When the incentive INC exceeds the cost required for the power reserve control PSC (S16: YES), the processing circuitry 31 advances the process to S17.

In the process of S17, the processing circuitry 31 executes the power reserve control PSC. The processing circuitry 31 executes, as the power reserve control PSC, a process of switching the traveling mode to the second traveling mode, and a process of increasing the target value of the first amount of electrical energy A_1 to be greater than the second amount of electrical energy A_2 and operating the engine 300 such that the first amount of electrical energy A_1 reaches the target value. Thus, the engine 300 operates such that the first amount of electrical energy A_1 is maintained to be greater than or equal to the second amount of electrical energy A_2. Thereafter, the processing circuitry 31 ends the series of processes.

### Operation of the First Embodiment

In order to cause the PHEV 20 to participate in the DR, it is necessary that the first amount of electrical energy A_1, which is the amount of electrical energy stored in the battery cells 23C, is greater than the second amount of electrical energy A_2, which is the amount of electrical energy required for causing the PHEV 20 to participate in the DR.

The amount of electrical energy consumed until the traveling PHEV 20 arrives at the house 92, which is the destination, varies depending on the travel route of the PHEV 20 and the traveling time until the arrival. If the travel route and the expected arrival time are known, the first amount of electrical energy A_1 at the time of arrival at the destination can be predicted.

The processing circuitry 31 predicts whether the first amount of electrical energy A_1 at the time of arrival at the destination will be less than the second amount of electrical energy A_2 by using the travel route to the destination, the expected time of arrival at the destination, the first amount of electrical energy A_1, and the second amount of electrical energy A_2.

When predicting that the first amount of electrical energy A_1 at the time of arrival at the destination will be less than the second amount of electrical energy A_2 (S15: YES), the processing circuitry 31 acquires data related to the incentive INC and the cost for the power reserve control PSC.

When the incentive INC exceeds the cost required when the power reserve control PSC is executed (S16: YES), the processing circuitry 31 executes the power reserve control PSC.

### Advantages of the First Embodiment

(1-1) The controller 30 can cause the PHEV 20 to be in a state of being able to participate in the DR before the PHEV 20 arrives at the destination.

(1-2) The processing circuitry 31 can select the first traveling mode and the second traveling mode. In the first traveling mode, the PHEV 20 is caused to travel by using the output of the motor-generator in a state in which the engine 300 is stopped. In the second traveling mode, the PHEV 20 is caused to travel by operating the engine 300. The processing circuitry 31 executes, as the power reserve control PSC, a process of switching the traveling mode to the second traveling mode, and a process of increasing the target value of the first amount of electrical energy A_1 to be greater than the second amount of electrical energy A_2 and operating the engine 300 such that the first amount of electrical energy A_1 reaches the target value. Accordingly, the controller 30 allows the PHEV 20 readily participate in the DR by switching the traveling mode to the second traveling mode.

(1-3) In a case in which the incentive INC to be paid is less than or equal to the cost required when the power reserve control PSC is executed, the user of the PHEV 20 suffers a disadvantage. The processing circuitry 31 executes the power reserve control PSC when the incentive INC to be paid exceeds the cost required to execute the power reserve control PSC. Accordingly, the controller 30 ensures financial benefit for the user of the PHEV 20.

### Modifications of the First Embodiment

The first embodiment may be modified as follows.

The processing circuitry 31 may execute the power reserve control PSC when predicting that the first amount of electrical energy A_1 at the time of arrival at the destination will be less than the second amount of electrical energy A_2. In this case, the processing circuitry 31 may not acquire the data related to the incentive INC and the cost incurred when the power reserve control PSC is executed.

### Second Embodiment

Hereinafter, the controller of the PHEV 20 according to the second embodiment will be described with reference to FIGS. 2 to 4. Hereinafter, differences from the first embodiment will be mainly described. The description of the same points as those in the first embodiment will be simplified or omitted.

In the second embodiment, the content of the power reserve control PSC executed by the processing circuitry 31 in the S17 process shown in FIG. 2 is different from that of the first embodiment.

As shown in FIG. 3, in the second embodiment, the PHEV 20 includes a display 33 for displaying an image. The display 33 may be a touch display capable of receiving a touch operation by the user. The PHEV 20 comprises a switch 34. The switch 34 is an operating member operated by a user of the PHEV 20. The switch 34 is configured to be able to switch the traveling mode of the PHEV 20 to a second traveling mode that is a prescribed traveling mode in which the engine 300 is operated to travel the PHEV 20. The switch 34 is, for example, a physical operating member provided in the vehicle. The operating member operated by the user of the PHEV 20 is not limited to the switch 34. For example, the operating member operated by the user in the PHEV 20 may be an image displayed on the display 33. In this case, the user can switch the traveling mode of the PHEV 20 to the second traveling mode by selecting the image displayed on the display 33.

The processing circuitry 31 executes a process of presenting the notification image IM on the display 33 as the power reserve control PSC in S17 illustrated in FIG. 2. As the power reserve control PSC, the processing circuitry 31 also executes a process of increasing the target value of the first amount of electrical energy A_1 in the second traveling mode to be greater than the second amount of electrical energy A_2, and operating the engine 300 such that the first amount of electrical energy A_1 reaches the target value in the second traveling mode. The notification image IM is a display for prompting the driver to select the second traveling mode, which is a prescribed traveling mode, by operating the switch 34. FIG. 4 shows an example of the notification image IM.

As shown in FIG. 4, the processing circuitry 31 displays, on the display 33, a message such as “Please operate the switch to select the second traveling mode.” Then, the display of the notification image IM including the content of "Start to display" is started. When the user operates the switch 34 to select the second traveling mode, the processing circuitry 31 ends the display of the notification image IM on the display 33. In a case in which a prescribed time elapses after the notification image IM is displayed on the display 33, the processing circuitry 31 may end the display of the notification image IM on the display 33.

### Operation of the Second Embodiment

When the second traveling mode is selected by operating the switch 34, the engine 300 is operated. When predicting that the first amount of electrical energy A_1 at the time of arrival at the destination will be less than the second amount of electrical energy A_2, the controller 30 presents, on the display 33, a notification image IM for prompting the user to select the second traveling mode, which is the prescribed traveling mode in which the engine 300 operates. In addition, the controller 30 increases the target value of the first amount of electrical energy A_1 in the second traveling mode to be greater than the second amount of electrical energy A_2. Accordingly, the opportunities for the engine 300 to operate is increased. Also, when the second traveling mode is selected, the engine 300 operates such that the first amount of electrical energy A_1 is maintained to be greater than or equal to the second amount of electrical energy A_2.

### Advantages of the Second Embodiment

In addition to the advantage (1-1) and (1-3) of the first embodiment, the second embodiment has the following advantages.

(2-1) The controller 30 can cause the PHEV 20 to easily participate in DR by prompting switching to the second traveling mode, which is the prescribed traveling mode.

### Third Embodiment

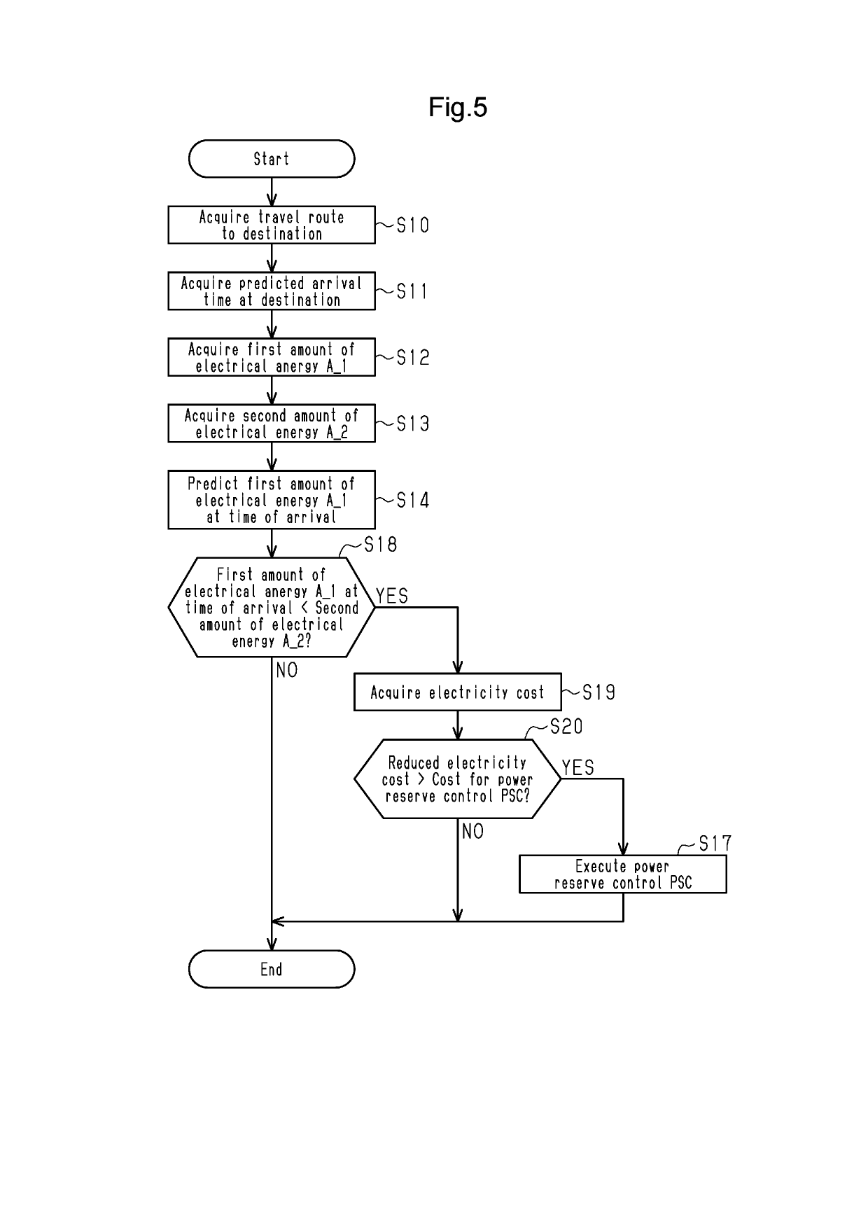

Hereinafter, the controller of the PHEV 20 according to the third embodiment will be described with reference to FIGS. 2 and 5. Hereinafter, differences from the first embodiment will be mainly described. The description of the same points as those in the first embodiment will be simplified or omitted. In the third embodiment, the content of the process in which the processing circuitry 31 determines whether to execute the power reserve control PSC is different from that of the first embodiment.

As shown in FIG. 5, the processing circuitry 31 of the controller 30 performs a series of processes for determining whether to execute the power reserve control PSC. The processing circuitry 31 executes the series of processes at each prescribed execution cycle during traveling on the PHEV 20. Since the processes from S10 to S14 shown in FIG. 5 are identical to the processes from S10 to S14 shown in FIG. 2, a detailed description thereof will be omitted. After ending the process of S14, the processing circuitry 31 advances the process to S18.

In the process of S18 illustrated in FIG. 5, the processing circuitry 31 predicts whether the first amount of electrical energy A_1 at the time of arrival at the destination will be less than the second amount of electrical energy A_2 using the first amount of electrical energy A_1 at the time of arrival at the destination and the acquired second amount of electrical energy A_2. In the process of S18, when predicting that the first amount of electrical energy A_1 at the time of arrival at the destination will be greater than or equal to the second amount of electrical energy A_2 (S18: NO), the processing circuitry 31 temporarily ends the series of processes. In the process of S18, when predicting that the first amount of electrical energy A_1 at the time of arrival at the destination will be less than the second amount of electrical energy A_2 (S18: YES), the processing circuitry 31 advances the process to S19.

In the S19 process, the processing circuitry 31 acquires the electricity cost of the electric power supplied from the power grid 91 to the house 92. When the electricity cost varies depending on the time slot, the processing circuitry 31 acquires the electricity cost in the time slot in which the PHEV 20 is caused to participate in the DR. The processing circuitry 31 acquires the electricity cost from the server 80, for example. Thereafter, the processing circuitry 31 advances the process to S20.

In the process of the S20, the processing circuitry 31 acquires an electricity cost to be reduced when the PHEV 20 participates in the DR. The processing circuitry 31 acquires the cost for the power reserve control PSC. Then, the processing circuitry 31 determines whether the reduced electricity cost is less than or equal to the cost required for the power reserve control PSC.

The reduced electricity cost is, for example, the product of the amount of electrical energy supplied from the PHEV 20 to the house 92 when the PHEV 20 is caused to participate in the DR and the electricity cost of the power supplied from the power grid 91 to the house 92 in the time slot in which the PHEV 20 is caused to participate in the DR.

When the reduced electricity cost is less than or equal to the cost required for the power reserve control PSC (S20: NO), the processing circuitry 31 temporarily ends the series of processes. In a case in which the reduced electricity cost exceeds the cost for the power reserve control PSC (S20: YES), the processing circuitry 31 advances the process to S17.

In the process of S17, the processing circuitry 31 executes the power reserve control PSC. Since the process of the S17 in the third embodiment is identical to the process of the S17 in the first embodiment, detailed description thereof will be omitted. Thereafter, the processing circuitry 31 ends this series of processes.

### Operation of the Third Embodiment

In a case in which the electricity cost that will be reduced when the PHEV 20 is caused to participate in the DR is less than or equal to the cost required when the power reserve control PSC is executed, the user of the PHEV 20 suffers a disadvantage. The controller 30 executes the power reserve control PSC when the reduced electricity cost exceeds the cost of executing the power reserve control PSC.

### Advantages of the Third Embodiment

In addition to the advantage (1-1) and (1-2) of the first embodiment, the third embodiment has the following advantages.

(3-1) The user of the PHEV 20 can secure financial profits.

### Modifications of the Third Embodiment

The third embodiment may be modified as follows.

The processing circuitry 31 may execute the power reserve control PSC when predicting that the first amount of electrical energy A_1 at the time of arrival at the destination will be less than the second amount of electrical energy A_2. In this case, the processing circuitry 31 may not acquire the electricity cost to be reduced in a case in which the PHEV 20 participates in the DR and the cost required in a case in which the power reserve control PSC is executed.

### Other Modifications

The following are modifications commonly applicable to the above-described embodiments. The following modifications can be combined as long as the combined modifications remain technically consistent with each other.

The power reserve control PSC is control for increasing the opportunity to operate the engine 300 so that the first amount of electrical energy A_1 at the time of arrival at the destination where the charging and discharging device 60 is provided becomes greater than or equal to the second amount of electrical energy A_2. Therefore, the first amount of electrical energy A_1 is allowed to be less than the second amount of electrical energy A_2 during the execution of the power reserve control PSC.

The power reserve control PSC is not limited to the switching of the traveling mode. The power reserve control PSC may be control for suppressing electric power consumption during traveling until arrival at a destination by increasing the operation amount of the engine 300 or increasing the first amount of electrical energy A_1 by electric power generation by the driving force of the engine 300.

In the process of S16 illustrated in FIG. 2, the processing circuitry 31 may compare a cost other than the cost for the power reserve control PSC with the incentive INC to be paid. In the process of S20 illustrated in FIG. 5, the processing circuitry 31 may compare the cost other than the cost for the power reserve control PSC with the reduced electricity cost. For example, the processing circuitry 31 calculates the price of the electric power stored in the battery cells 23C based on the mileage of the PHEV 20 when only the electric power of the battery cells 23C is used and the fuel cost when only the engine 300 is used to travel the mileage. The processing circuitry 31 may execute the power reserve control PSC when the incentive INC to be paid is larger than the price of the power stored in the battery cells 23C to be consumed when the PHEV 20 is caused to participate in DR. The processing circuitry 31 may execute the power reserve control PSC when the reduced electricity cost is larger than the price of the power stored in the battery cells 23C that is consumed when the PHEV 20 is caused to participate in the DR.

The processing circuitry 31 may include circuitry including one or more processors that perform various processes according to computer programs (software). The processing circuitry 31 may be circuitry including one or more dedicated hardware circuits such as application specific integrated circuits (ASIC) that execute at least part of various processes, or a combination thereof. Each processor includes a CPU and memory such as RAM and ROM. The memory stores program codes or commands configured to cause the CPU to execute processes. The memory, namely, a computer-readable medium, includes any available medium that is accessible by a general-purpose or special-purpose computer. Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller for a plug-in hybrid electric vehicle, wherein
the plug-in hybrid electric vehicle includes:
an engine and a motor-generator that are power sources for driving drive wheels;
a battery cell that supplies electric power to the motor-generator, and stores electric energy generated by the motor-generator using output of the engine; and
a connection port configured to electrically connect an external charging and discharging device and the battery cell,
the plug-in hybrid electric vehicle is configured to participate in a demand response by being electrically connected to the charging and discharging device,
the controller comprises processing circuitry,
the processing circuitry is configured to
acquire a travel route to a destination where the charging and discharging device is provided;
acquire an expected time of arrival at the destination;
acquire a first amount of electrical energy that is an amount of electrical energy stored in the battery cell;
acquire a second amount of electrical energy that is an amount of electrical energy required for the plug-in hybrid electric vehicle to participate in the demand response;
predict whether the first amount of electrical energy at the time of arrival at the destination will be less than the second amount of electrical energy using the acquired travel route, the estimated arrival time, the first amount of electrical energy, and the second amount of electrical energy; and
when predicting that the first amount of electrical energy at the time of arrival at the destination will be less than the second amount of electrical energy, execute a power reserve control to increase opportunities to operate the engine such that the first amount of electrical energy at the time of arrival at the destination will be greater than or equal to the second amount of electrical energy.

2. The controller for the plug-in hybrid electric vehicle according to claim 1, wherein
the processing circuitry is capable of selecting one of following modes as a traveling mode of the plug-in hybrid electric vehicle:
a first traveling mode that causes the plug-in hybrid electric vehicle to travel by using output of the motor-generator in a state in which the engine is stopped; and
a second traveling mode that causes the plug-in hybrid electric vehicle to travel by operating the engine, and
in the power reserve control, the processing circuitry is configured to
switch the traveling mode to the second traveling mode, and
increase a target value of the first amount of electrical energy to be greater than the second amount of electrical energy, and operate the engine such that the first amount of electrical energy reaches the target value.

3. The controller for the plug-in hybrid electric vehicle according to claim 1, wherein
the plug-in hybrid electric vehicle includes:
a display that displays an image; and
an operating member operated by a user of the plug-in hybrid electric vehicle,
the operating member is configured to switch a traveling mode of the plug-in hybrid electric vehicle to a prescribed traveling mode that causes the plug-in hybrid electric vehicle to travel by operating the engine,
in the power reserve control, the processing circuitry is configured to
present, on the display, content prompting selection of the prescribed traveling mode by operating the operating member, and
increase a target value of the first amount of electrical energy in the prescribed traveling mode to be greater than the second amount of electrical energy, and operate the engine such that the first amount of electrical energy reaches the target value in the prescribed traveling mode.

4. The controller for the plug-in hybrid electric vehicle according to claim 1, wherein the processing circuitry is configured to
acquire data related to an incentive to be paid to a user of the plug-in hybrid electric vehicle when the plug-in hybrid electric vehicle is caused to participate in the demand response,
acquire a cost required for the power reserve control, and
execute the power reserve control when the incentive exceeds the cost.

5. The controller for the plug-in hybrid electric vehicle according to claim 1, wherein the processing circuitry is configured to
acquire an electricity cost that will be reduced when the plug-in hybrid electric vehicle is caused to participate in the demand response;
acquire a cost required for the power reserve control, and
execute the power reserve control when the reduced electricity cost exceeds the cost.
